(19) United States
(12) Patent Application Publication
(10) Pub. No.: US 2012/0113248 A1
(43) Pub. Date: May 10, 2012

(54) DEVICE FOR INSPECTING CONTAINERS

(75) Inventor: Rudolf Fiegler, Regensburg (DE)

(73) Assignee: KRONES AG, Neutraubling (DE)

(21) Appl. No.: 13/292,349

(22) Filed: Nov. 9, 2011

(30) Foreign Application Priority Data
Nov. 9, 2010 (DE) 102010043635.6

(51) Int. Cl. H04N 7/18

(52) U.S. Cl. 348/125; 348/E07.085

(57) ABSTRACT

Device for inspecting containers or the like, in particular bottles of glass or plastics, with an inspection module mounted at a conveying path, where, be able to adapt the device more flexibly to corresponding customer demands and to reduce assembly and adjustment works, the device is formed as a modular inspection unit with a support with location places for a plurality of inspection modules.

### CROSS-REFERENCE TO RELATED APPLICATION

The present application claims the benefit of priority of German Application No. 102010043635.6, filed Nov. 9, 2010. The entire text of the priority application is incorporated herein by reference in its entirety.

### FIELD OF THE DISCLOSURE

The disclosure relates to a device for inspecting containers or the like of the type used in beverage and food processing operations.

### BACKGROUND

Such a device is known from EP-A-1 811 289. The known device is allocated to a conveying path for the containers, in particular bottles of glass or plastics, and is to detect, for example, foreign matter, foreign substances or the like present in the bottle, and to take care that these bottles are removed from the further handling path; i.e. the known device is especially designed for inspecting returned refillable containers before these are forwarded to the next filling process. In the known device, inspection is performed by an inspection module which comprises a light source on the one side of the conveying path, and a light detector on the other side of the conveying path. The light source and the light detector, however, must be individually attached at the conveying path and individually adjusted with respect to the conveying path.

These assembly and adjustment works, however, are relatively elaborate, in particular if several transmitter/receiver units or several sensors must be installed, as is in particular required with returning refillable containers. Moreover, the replacement of the sensors or transmitter/receiver units is also elaborate if, for example, defective elements must be replaced, or complete units must be exchanged or not required units be put out of service. Moreover, for a customer-oriented manufacture of the complete device, a high degree of individual production is required.

### SUMMARY OF THE DISCLOSURE

Thus, it is one aspect the disclosure is to provide a device for inspecting containers or the like which can be universally and flexibly employed.

By the completely modular design of the device, a wide range of changes without a lot of efforts and with a great reduction in the degree of customer-specific individual production are possible. Moreover, defective inspection modules can be easily exchanged. Moreover, the major part of assembly and adjustment works can be effected or at least prepared already outside the plant.

If the support is provided with all-purpose interfaces at each location place, inspection modules can be connected at any arbitrary points where they are required, while their connection point can be easily determined via a control system.

The interfaces can be embodied either via a connection rail which can accommodate several inspection modules, or a corresponding number of plug-in positions for one inspection module each.

Preferably, the support also contains a location place for a moving means for the containers having the purpose of bringing the containers into a position advantageous for inspection, so that the relative allocation between the moving means and the position of the container which is moved by the latter is determined in advance, and further adjustment works for the inspection modules are omitted.

If the inspection modules are provided with identical connections, they can be easily connected with each interface at the support.

The cabling of the interfaces with the control system is preferably effected via a bus system which on the one hand reduces the amount of required cables, and on the other hand permits an essentially more elegant and versatile transmission of signals.

Preferably, the inspection elements of each inspection module are fixed to a common assembly frame already preadjusted with respect to the arrangement of the support, so that here, too, the amount of adjustment works is reduced.

The disclosure is particularly suited for inspection modules which contain a camera, a lighting means and a drive for adjustment movements, for example for focusing.

Furthermore, a container detection means can be allocated to the inspection module which detects early enough that a container approaches the module or enters the measuring region of the module.

### BRIEF DESCRIPTION OF THE DRAWINGS

One embodiment of the disclosure will be illustrated below more in detail with reference to the drawings. In the drawings:

FIG. 1 shows a perspective representation of a device according to the disclosure,

FIG. 2 shows a perspective representation of a support,

FIG. 3 shows a perspective representation of the device according to FIG. 1 with an extension,

FIG. 4 shows a perspective representation of an exemplary inspection module, and

FIG. 5 shows a perspective representation of an exemplary modular moving means.

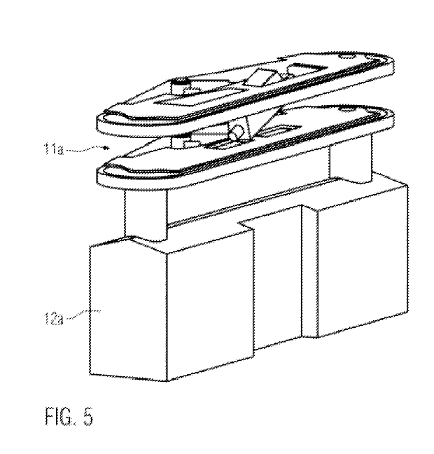

### DETAILED DESCRIPTION OF THE PREFERRED EMBODIMENT

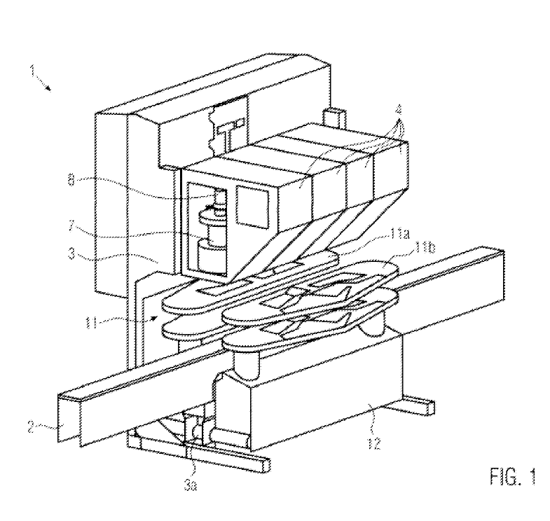

FIG. 1 shows a perspective representation of an inventive modular device 1 for inspecting containers, in particular bottles of translucent material, for example glass or plastics, which can be arranged in the most diverse handling paths of the containers and adapted to them, but in the represented embodiment can be employed for the inspection of refillable containers before they are refilled.

However, the present disclosure can also be employed in other fields of manufacturing and filling food containers, that means e.g. for the inspection of preforms or closures, and in the manufacture or for the inspection of the filling operation or condition, respectively. Apart from bottles, the containers can also be cans or glasses of very diverse materials.

The device 1 is allocated to a conveying path 2 for the containers which is embodied as a conveyor means of any known type.

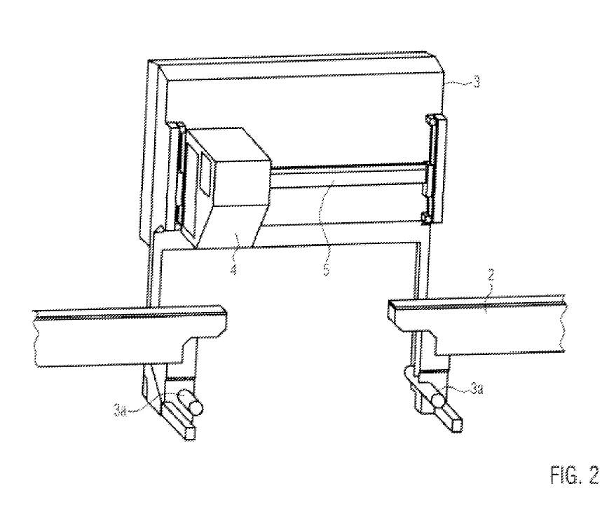

As is shown in FIG. 2, a support 3 is stationarily arranged, e.g. via a detachable and adjustable mounting 3a, in a predetermined arrangement with respect to the conveying path 2, where the support can receive a plurality of identical or different modular components, in particular inspection modules 4. To this end, the support 3 contains a plurality of location places for one of the inspection modules 4 each, wherein each location place is provided with an all-purpose, preferably standardized electric/electronic interface and an all-purpose mechanical holding means, wherein the interface is preferably embodied as a mechatronic interface. The location places are, in the represented embodiment, embodied on a linear location element, in particular a location rail 5, which essentially extends parallel to the conveying path 2 and is long enough to receive a plurality of inspection modules 4 side by side. The location rail 5 is preferably adjustable relative to the conveying path 2. The location rail 5 functions as a mechanical mounting as well as for supplying all modules 4 mounted on the location rail 5 with electric energy and for transmitting signals from and to a control system, preferably via a bus system. By employing all-purpose interfaces, the modules can be freely positioned, while no increased amount of cables is required if a bus system is used.

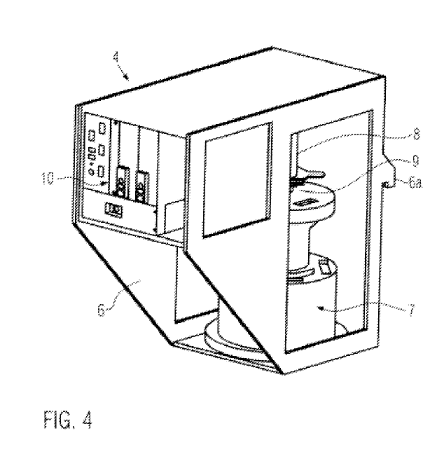

FIG. 4 shows, in a perspective representation, one of the employed modules 4. The inspection module 4 contains an assembly frame 6 which is embodied like a protective housing in the represented embodiment. Preferably, all inspection modules 4 are embodied with identical assembly frames 6, even if they contain different inspection elements. The represented inspection module 4 contains all inspection elements necessary for the operation, that means in particular a signal transmitter 7, here in the form of a lighting, for example a mouth double lightning, and a signal receiver 8, for example a camera, as well as a moving means 9, for example a servomotor for focusing or for other movements of the elements 7, 8 of the module 4. Depending on the type of signal transmitter/signal receiver, a control system 10 can be furthermore provided which, for example, takes care of signal processing (image processing). The inspection module 4 is preferably independent, i.e. the control system 10 is able to process all data required for a decision of good or bad.

At a predetermined point of the assembly frame 6, a mechanical holding means 11 with allocated, also all-purpose electric/electronic connections is provided which match a plurality of connection points at the support 3. Since the arrangement of the holding means 11 at the assembly frame 6 and its arrangement at the connection rail 5, as well as the position of the connection rail 5 with respect to the conveying path 2 are known or can be determined, the components of the inspection module can be installed in the assembly frame 6 in a preadjusted manner, so that the modules 4 are operable immediately after they have been hung up into the connection rail 5.

Apart from the described elements, the module 4 can also be provided with further elements required or suitable for the type of inspection elements, for example with a container detection means, such as a light barrier, which can thereby be mounted at a fixed distance to the center of the object if a camera is employed, so that, for example, the corresponding inspection elements, being adapted to the transport speed of the containers in the conveying path 2, can be switched to be operative as soon as a container approaches the corresponding module 4. The container detection means can be fixed directly in or at the allocated module 4, or be embodied as separate detection module and e.g. arranged at a predetermined location place in or at the conveying path 2 (e.g. in series with the inspection modules 4 on the location rail 5 or on a plug-in position or the like).

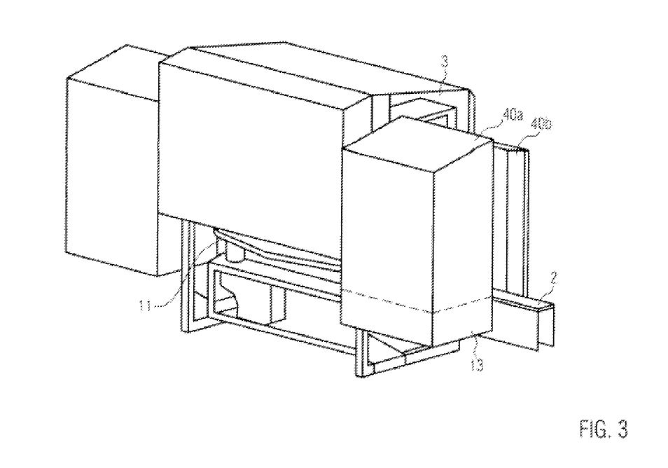

The inspection modules 4 are hung up at the connection rail 5 such that they are located above the containers on the conveying path 2. If a certain type of inspection requires the inspection elements to be arranged at other places, an extension can be attached laterally (or else underneath) at the support 3, as shown in FIG. 3, where there, too, all-purpose electric/electronic as well as mechanical interfaces are provided which match a majority of the modules. These can be here, too, either embodied as connection rails or as plug-in positions where further inspection modules 40 can be connected to the support 3 by insertion. In the represented embodiment, these are the inspection elements 40a, 40b of so-called boxes of mirrors which are employed for a side wall control of the containers. For this job, the elements 40a, 40b must be arranged at both sides of the conveying path 2, so that the container wall is optimally reached by the measuring signals.

The inspection modules 40 are also received in a corresponding assembly frame (preferably a housing) which is provided with the standardized interfaces at the predetermined place, so that, when it is connected to the support 3, the inspection modules 40 are also optimally oriented to the conveying path 2 and further adjustment works will not be required.

For certain inspection purposes, it is necessary to transport the containers through the inspection device 1 separate from the conveying path 2, or for example rotate or tilt them. For these cases, the device 1 contains a moving means 11 which also has a modular design. The moving means 11 contains two mirror-inverted conveyor units 11a, 11b which each consist of two continuous belts situated one above the other and acting at the container's wall, while it is, however, possible in case of low containers to only provide one of the belts. The conveyor units 11a, 11b can be controlled independently, their motors being accommodated in one housing 12a, 12b each which is at predetermined points provided with mechanical and electric/electronic interfaces to be connected to corresponding interfaces at the support 3 in the manner already described above. In the represented embodiment, these are e.g. a connection rail or plug-in positions disposed underneath the conveying path 2 onto which the moving elements 11a, 11b with their housings 12a, 12b are placed. By this, too, the position of the moving elements 11a, 11b with respect to the conveying path 2 is fixed, so that a preadjustment can be made outside the machine.

Depending on the requirement, the main control of the device 1 according to the disclosure can also be arranged at the support 3, for example accommodated in a separate region 13 of one of the housings 40a of the inspection module 40, which region is reserved for this purpose, the module being correspondingly enlarged to this end, or in a separate housing.

Independent of the arrangement of the control system, the pulses and signals are transmitted via a bus system, so that an address can be allocated to each of the modules 4, 40, 11, permitting to arrange in particular the inspection modules 4, 40 at the most diverse location places, depending on the operating requirements, without any cables having to be installed again. By this, it is furthermore possible to keep location places free and bridge them by the bus system, so that not required modules can be easily omitted. By this, it is furthermore possible to exchange the described inspection modules 4 against other modules, or the described moving module 11 against another moving module, which is, for example, adapted to another shape of the containers or to other movement patterns.

In variation to the described and drawn embodiments, modules can also be employed with other inspection elements than a camera and lighting. The arrangement of the modules along the connection rails or on the plug-in positions can be freely selected, so that e.g. the moving means or an inspection module can also be embodied to be traversing along a connection rail.

1. Device for inspecting containers, comprising an inspection module mounted at a conveying path, the inspection module comprising a modular inspection unit with a support with location places for a plurality of inspection modules.

2. The according to claim 1, wherein the support is provided with all-purpose one of electrical interfaces, electronic interfaces, and mechanical interfaces at each location place for one inspection module each.

3. The according to claim 1, wherein the support contains at least one connection rail for receiving several inspection modules.

4. The according to claim 1, wherein the support comprises a plurality of plug-in positions for one inspection module each.

5. The according to claim 1, wherein the support comprises a location place for a moving module for the containers.

6. The according to claim 1, wherein the inspection modules are provided with identical connections to be connected to one of a plurality of similar location places at the support.

7. The according to claim 6, wherein each location place is connected with a control system via a bus system.

8. The according to claim 1, wherein the inspection module comprises a plurality of inspection elements in a common assembly frame in an arrangement adjusted with respect to the arrangement of the support with respect to the conveying path.

9. The according to claim 8, characterized in that wherein the inspection module contains a camera, a lighting means and a drive for adjusting movements, combined in an assembly frame.

10. The according to claim 1, and wherein a container detection means is allocated to the inspection module.

11. The according to claim 3, wherein the connection rail is a linear element.

12. The device according to claim 1, wherein the containers being inspected are bottles of one of glass and plastic.
